(19) United States
(12) Patent Application Publication
(10) Pub. No.: US 2008/0205057 A1
(43) Pub. Date: Aug. 28, 2008

(54) LIGHT SOURCE DEVICE ASSEMBLY

(75) Inventors: Wen-Ho Chen, Hsinchu City (TW); Ming-Kang Chen, Hsin-Chu City (TW); Mao-Ching Yang, Hsin-Chu City (TW)

Correspondence Address: VENABLE LLP, P.O. BOX 34385, WASHINGTON, DC, 20043-9998, US

(73) Assignees: Frontend Analog and Digital Technology Corporation, Taipei City (TW); J.S. Technology Co., Ltd., Hsinchu City (TW)

(21) Appl. No.: 11/678,482

(22) Filed: Feb. 23, 2007

(51) Int. Cl. F21V 21/00

(52) U.S. Cl. 362/249

(57) ABSTRACT

A novel light source device assembly comprises a substrate, a plurality of light source devices and a heat dissipation plate. In the substrate, a plurality of through holes is provided at a plurality of predetermined positions, to support the plurality of light source devices. In the heat dissipation plate, at positions corresponding to that of the plurality of through holes, a plurality of upwardly protruded tongue pieces is provided, whereby each tongue piece is in contact with its respectively corresponding light source device in the plurality of through holes. Metal solders may be applied in between the plurality of tongue pieces and their corresponding plurality of light source devices to enhance the heat dissipation efficiencies. Necessary circuitry may be provided in the substrate and the circuitry may be in connection with the light source device electrically.

### FIELD OF THE INVENTION

The present invention relates to a light source device assembly, especially to a light source assembly using the light emitting diode (LED) array as its light source. The present invention also discloses a heat dissipation plate to be used in the invented light source device assembly.

### BACKGROUND OF THE INVENTION

Due to the enhancement of the light generation efficiency of the light emitting diode (LED), the lighting device using the small-scaled and highly efficient light emitting component such as the LED has become popular in the past few years. Nowadays a plurality of LED lighting equipments is made commercially available, including the LED lights or indicator lights and other lighting devices or displaying devices that use the LED array as their light sources.

When the LED is used as the light source an array or a matrix of LED's is needed. In such a case, the heat dissipation is one of the major concerns. Especially when the LED's are positioned closely in the array or the matrix, how the heat generated by the LED's or by other components may be effectively guided and released is the most important task in the preparation of LED arrays that may operate normally with sufficient efficiency for a sufficiently long time.

FIG. 1 shows the cross-sectional view of a conventional light source device assembly. As shown in this figure, the conventional light source device includes a substrate 1 which in this example is a printed circuit board, a plurality of light source devices 2, 2 which in this example are LED bulbs positioned in the substrate 1 and a heat dissipation plate 3 positioned beneath the substrate 1. The substrate 1 has a plurality of through holes 11, 11, to hold the plurality of light source devices 2, 2 in the plurality of holes 11, 11. The light source devices 2, 2 include an LED 21 and two electrodes 22 and 23 connected to the LED 21. The two electrodes 22 and 23 extend to contact the pad 34 of the substrate 1, to electrically connect the circuitry (not shown) in the substrate 1. In the substrate 1, necessary control circuits, power circuits, protection circuits etc. (all not shown) are provided. The light source device 2 also includes its package 25 which contains a heat sink (not shown) inside it.

The heat dissipation plate 3 is a plate made of materials of high thermal conductivities. The heat dissipation plate 3 guides the thermal energy generated by the light source devices 2, 2 to the whole area of the heat dissipation plate 3 and releases the thermal energy to the environment. In order to enhance the heat dissipation efficiency, a heat sink 35 is provided on the heat dissipation plate 3, in positions corresponding to the through holes 11, 11 in the substrate 1. Adhesive materials with higher thermal conductivities such as thermal adhesives or thermal greases 31 are applied to the top surface of the heat sink 35, to contact the light source device 2 when the heat dissipation plate 3 is fixed to the substrate 1 and the light source devices 2, 2 are positioned in the through holes 11, 11 of the substrate 1. The thermal energy generated by the light source device 2 is transferred to the heat dissipation plate 3 from the bottom parts of the light source device 2 through the thermal adhesives or the thermal greases 31 and, then, released to the environment.

The above-described conventional light source device assembly may effectively release the thermal energy generated by the light source devices to the environment. It however has several drawbacks.

First, the heat dissipation plate 3 is a plan plate. When the light source device is an LED array, it would include a plurality of LED bulbs, in the number of from several tens to several hundreds. To support such an LED array, the substrate and the heat dissipation plate need to be in a large space. As a result, the contacts between the LED bulbs and the heat dissipation plate are not ensured. Although the use of the heat sink 35 solves this problem to some extends, such an additional component and its assembly process contribute to increasing the costs and difficulties in the processing and assembly of the light source device assembly.

In addition, the thermal adhesive or the thermal grease 31 is a high molecular composition that exhibits relatively high heat conductivities. Its thermal conductivity, however, is far lower than that of the metal. Nevertheless, in practice, the thermal adhesive or the thermal grease needs to be applied to between the substrate and the heat dissipation plate at the whole area to form a layer. The layer of the thermal adhesive or the thermal grease 31 is always thicker than a layer of the metal solder that is used in the industry. The use of the thermal adhesive or the thermal grease 31 makes the light source device assembly bulky.

The heat sink 35 and the thermal adhesive or thermal grease 31 need to be applied to the heat dissipation plate 3 manually. The costs in the manufacture of the light source device assembly are thus made higher, adding to the low yield rate of the products.

Nevertheless, in order to efficiently release the heat generated by the LED bulbs, the MCPCB (metal cored printed circuit board) was proposed to replace the assembly of the substrate 1 and the heat dissipation plate 3. This technology, however, is high-cost and is not practicable since in the MCPCB the electricity, the electronic signals and the heat share the same channels.

It is therefore necessary to provide a novel light source device assembly that may be processed and assembled easily, with relatively high yield rates.

It is also necessary to provide a light source device assembly with a simplified structure.

It is also necessary to provide a light source device that may be prepared under relatively low costs.

It is also necessary to provide a light source device with higher heat dissipation efficiencies.

### OBJECTIVES OF THE INVENTION

The objective of the invention is to provide a novel light source device assembly that may be processed and assembled easily, with relatively high yield rates.

Another objective of this invention is to provide a light source device assembly with a simplified structure.

Another objective of this invention is to provide a light source device that may be prepared under relatively low costs.

Another objective of this invention is to provide a light source device with higher heat dissipation efficiencies.

### SUMMARY OF THE INVENTION

According to the present invention, a novel light source device assembly is provided. The light source device assembly of this invention comprises a substrate, a plurality of light source devices and a heat dissipation plate. In the substrate, a plurality of through holes is provided at a plurality of predetermined positions, to support the plurality of light source devices. In the heat dissipation plate, at a plurality of predetermined positions corresponding to the positions of the plurality of through holes, a plurality of upwardly protruded tongue pieces is provided, in a manner that each tongue piece is in contact with its respectively corresponding light source device in the plurality of through holes. Metal solders may be applied in between the plurality of tongue pieces and their corresponding plurality of light source devices to enhance the heat dissipation efficiencies. Necessary circuitry may be provided in the substrate and the circuitry may be in connection with the light source device electrically.

In the present invention, the heat dissipation plate contacts firmly with all the light source devices, whereby the heat dissipation efficiency of the assembly is enhanced. The tongue pieces of the heat dissipation plate are formed automatically by using a presser. No additional components are needed. The metal solders may be applied to the top surface of the tongue pieces using a machine. The costs and process of the light source device assembly are thus saved and the yield rate of the assembling process is thus increased.

These and other objectives and advantages of this invention may be clearly understood from the detailed description by referring to the drawings.

### BRIEF DESCRIPTION OF THE DRAWINGS

FIG. 1 shows the cross-sectional view of a conventional light source device assembly.

FIG. 2 illustrates the cross-sectional view of one embodiment of the invented light source device assembly.

### DETAILED DESCRIPTION OF THE INVENTION

The structure and the preparation of the embodiments of the invented light source device assembly will be described in details in the followings. It shall be noted that the detailed descriptions are used to illustrate the present invention. They shall not be used to limit the scope of the invention. The scope of protection of the present invention shall only be limited by the claims.

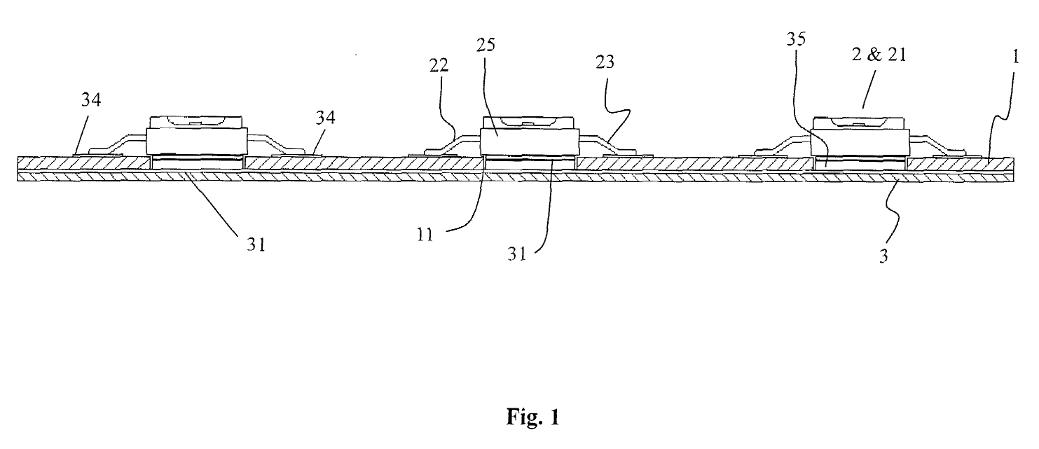

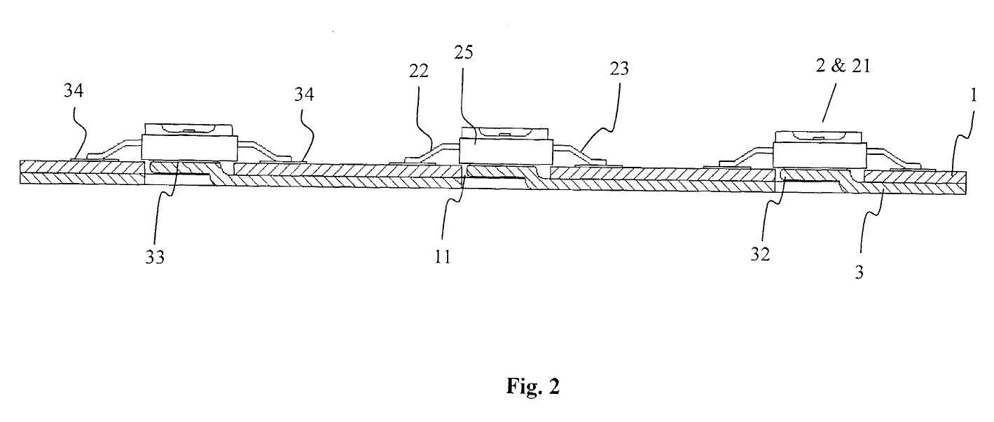

FIG. 2 illustrates the cross-sectional view of one embodiment of the light source device assembly of this invention. Components that are the same as those in FIG. 1 are labeled with the same numbers. As shown in FIG. 2, the light source device assembly of this invention also includes a substrate 1, a plurality of light source devices 2, 2 positioned in the plurality of through holes 11, 11 provided in the substrate 1 and a heat dissipation plate 3 positioned under the substrate 1 and in connection with the plurality of light source devices 2, 2.

In the present invention, the substrate 1 may be any substrate that is able to support the plurality of light source devices 2, 2 and other necessary circuits and electronic components. Because the light source device assembly includes a plurality of light source devices, the power circuits, control circuits, protection circuits etc. provided in the assembly are complicated. Therefore, the substrate 1 is preferably a commercially available multi-layered printed circuit (PC) board. Of course, PC boards of other material and structure and other types of substrate are also usable in this invention.

In the embodiment of FIG. 2, the light source device 2 is the LED bulb. The LED bulb 2 includes an LED 21, two electrodes 22, 23 and a package 25. The LED is a small scaled, lower power consumption and highly illuminant light source. It generates light beams of particular frequency bands. Under the currently available technology, it is necessary to use a plurality of LED bulbs in order to generate sufficient illumination for lighting purposes. As a result, how to provide an efficient thermal dissipation system for the plurality of LED bulbs has become the most important task in the preparation of the light source device assembly. Other types of small scaled and highly illuminant light source, such as the high intensity discharge light bulb, may be used in the replacement of the LED bulb. However, the thermal dissipation system is still a problem to be overcome.

The heat dissipation plate 3 of this invention is used to enhance the heat dissipation efficiency of the light source device assembly. In the heat dissipation plate 3, at positions corresponding to the through holes 11, 11 of the substrate 1, a plurality of upwardly extruded tongue pieces 32, 32 in the reversed L shape are provided. The height of the tongue pieces 32, 32 is not limited to any figure, as long as it allows the tongue pieces 32, 32 to effectively contact the bottoms of the corresponding light source devices 2, 2 positioned in the through holes 11, 11. The preparation of the tongue pieces 32, 32 is not limited to any particular method. Any method that is able to produce the reverse L shaped tongue pieces extruded upwardly from the heat dissipation plate 3 is applicable in this invention. Generally speaking, the tongue pieces are preferably formed by pressing a metal plate using a press machine. The heat dissipation plate, along with the tongue pieces, may thus be easily prepared using a conventional machine and regular moulds. No additional components such as the heat sink in the conventional art are needed. Of course, other method that is able to form the extruded tongue pieces may also be used in the present invention.

The material of the heat dissipation plate 3 is preferably a material with relatively high heat dissipation efficiencies. Applicable materials include: aluminum, tin, copper, silver, iron, indium and other metals, and other alloys. The heat dissipation plate 3 may be made of a material containing the metal, a ceramic material or have a multi-layered structure with layers of a variety of materials. If it is made of a metal material, the anodic oxidation treatment may be applied to the surface of the heat dissipation plate. The anodic oxidation treatment makes the internal of the plate thermally conductive, while the surface of the plate is not electrically conductive. The heat conductive channels and the electricity conductive channels are so separated that the electronic components and the pads that may be provided in the substrate 1 are not impacted by the heat being transmitted in the heat dissipation plate 3.

There are no particular limitations in the shape and the thickness of the heat dissipation plate 3. Solders 33, 33 may be applied to the tongue pieces 32, 32. The tin solder is one of the applicable materials of the solder. Other commercially available solders that provide relatively high thermal conductivities may also be used in this invention. The solders 33, 33 may be applied to the surface of the tongue pieces 32, 32 using any commercially available technique. In the embodiments of this invention, the solders 33, 33 are applied to the tongue pieces 32, 32 using a screen printer.

When assembled, the substrate 1 is first assembled with the heat dissipation plate 3, whereby the tongue pieces 32, 32 of the heat dissipation plate 3 are positioned inside the corresponding through holes 11, 11 of the substrate 1. Solders 33, 33 may be applied to the tongue pieces 32, 32 before or after the assembly of the substrate 1 and the heat dissipation plate 3. Then the light source devices 2, 2 are positioned in the through holes 11, 11, in touch with the solders 33, 33 of the tongue pieces 32, 32. The light source devices 2, 2 are then welded to the tongue pieces 32, 32 with an applicable method. The method used to weld the light source devices 2, 2 on the tongue pieces 32, 32 may be any commercially available method, including the ultrasonic welding technology and the surface mounting technology.

The light source devices 2, 2 may be positioned in the substrate 1 in any arrangement. Generally speaking, they may be arranged in matrix. They may be distributed in the substrate 1 in an irregular arrangement or in any pattern. After the light source devices 2, 2 are welded to the tongue pieces 32, 32 of the heat dissipation plate 3, the electrodes 22, 23 of the light source devices 2, 2 are connected to the pads 34, 34 provided in the substrate 1. The light source device assembly of this invention is thus prepared. In the substrate, power circuits, control circuits, protection circuits, detecting circuits, signal receiving/transmission circuits, logic circuits and other circuits and necessary wires may be provided. Other electronic and non-electronic components may also be provided in the substrate 1.

The light source device assembly prepared as described above has a simplified structure. No additional component such as the heat sink in FIG. 1 is necessary. The costs in the production of the light source device assembly may thus be reduced. The light source device assemblies may be prepared and assembled automatically, without the need of manual operations. The yield rate may also be improved. In addition, the assembly includes the separate layers of the substrate 1 and the heat dissipation plate 3 separated from each other, whereby the heat conductive channels and the electricity conductive channels are separated. Possible thermal impacts brought to the electronic components and the pads of the substrate 1 may thus be avoided. The heat dissipation plate 3 and the light source devices 2, 2 have direct thermal contacts between them. The heat dissipation efficiencies may further be improved.

As the present invention has been shown and described with reference to preferred embodiments thereof, those skilled in the art will recognize that the above and other changes may be made therein without departing form the spirit and scope of the invention.

What is claimed is:

1. A light source device assembly, comprising a substrate, a plurality of light source devices and a heat dissipation plate; wherein a plurality of through holes is provided in predetermined positions of said substrate to hold said plurality of light source devices; wherein each light source device is positioned in one of said plurality of through holes; and wherein a plurality of upwardly extruded tongue pieces is provided in predetermined positions of said heat dissipation plate whereby said plurality of tongue pieces is in contact with said plurality of light source devices.

2. The light source device assembly according to claim 1, wherein said light source device comprises an LED bulb.

3. The light source device assembly according to claim 1, wherein said light source device comprises a discharge light bulb.

4. The light source device assembly according to claim 1, wherein said substrate is a multilayer printed circuit board.

5. The light source device assembly according to claim 1, wherein said heat dissipation plate is a metal plate treated with the anodic oxidation.

6. The light source device assembly according to claim 1, wherein said plurality of tongue pieces is provided in positions corresponding to positions of said plurality of through holes.

7. The light source device assembly according to claim 6, wherein solders are applied to upper surface of said tongue pieces.

8. The light source device assembly according to claim 7, wherein said solder comprises a metal solder.

9. The light source device assembly according to claim 8, wherein said solder comprises a tin solder.

10. The light source device assembly according to claim 1, wherein said plurality of light source devices forms a matrix in said substrate.
